(19) United States
(12) Patent Application Publication
(10) Pub. No.: US 2010/0235163 A1
(43) Pub. Date: Sep. 16, 2010

(54) METHOD AND SYSTEM FOR ENCODING CHINESE WORDS

(76) Inventor: CHENG-TUNG HSU, Taipei (TW)

Correspondence Address: CHENG-TUNG HSU, 10F 413 Lin Shen N Road, Taipei, 104, omitted

(21) Appl. No.: 12/405,171

(22) Filed: Mar. 16, 2009

(51) Int. Cl. G06F 17/27

(52) U.S. Cl. 704/9

(57) ABSTRACT

A Chinese character or word encoding system and method for encoding a Unicode Differentiation Index (UDI) into the least significant 3 bits of one of the three component color of the foreground color of the RTF Chinese text. This encoded UDI value allows the correct identification of the encoded Chinese word. It also allows the identification of the traditional Chinese or simplified Chinese counterpart correctly. Further, the encoded UDI allows the identification of the font file differentiator when user is generating a correct Dualese script for a given Chinese word, wherein Dualese refers to a dual-script-in-one type of script.

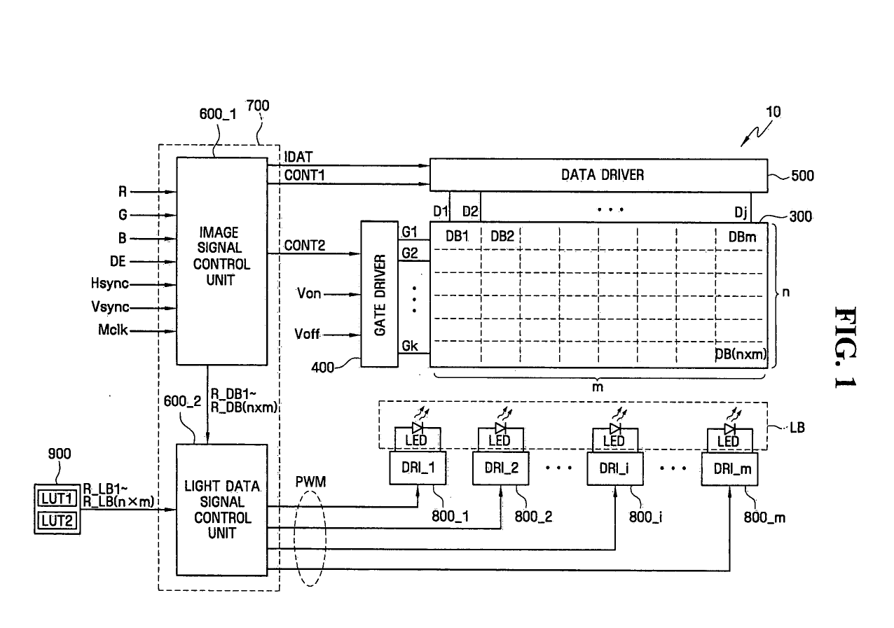

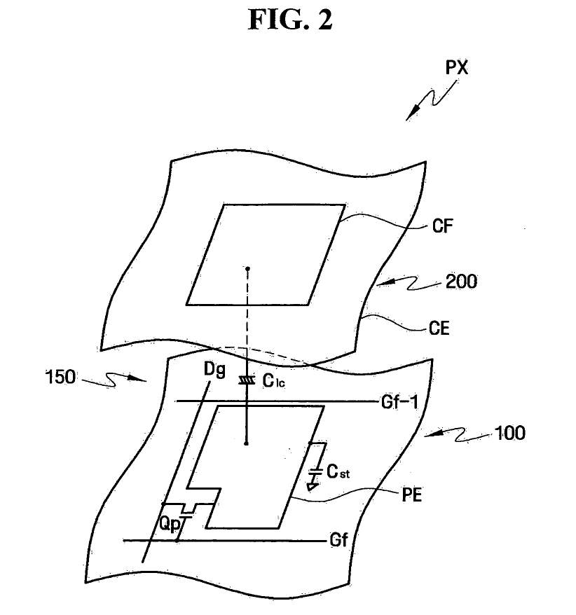

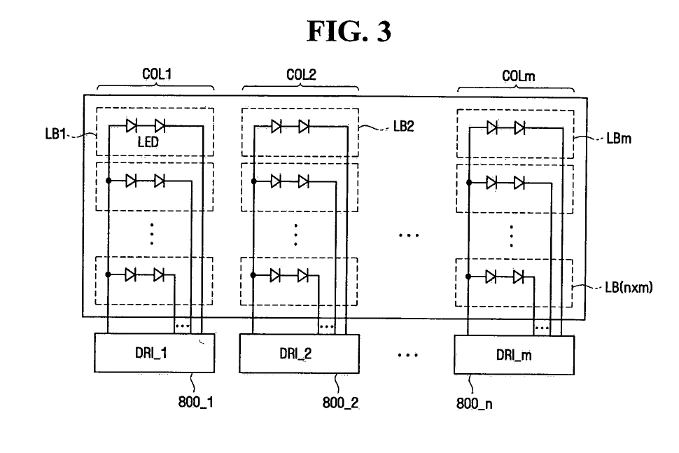

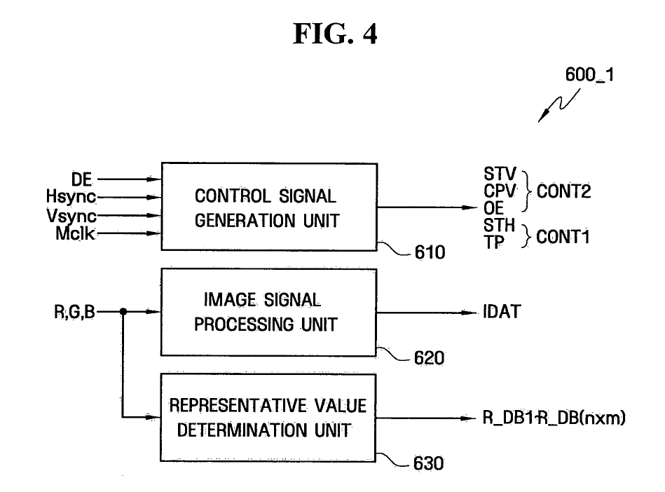

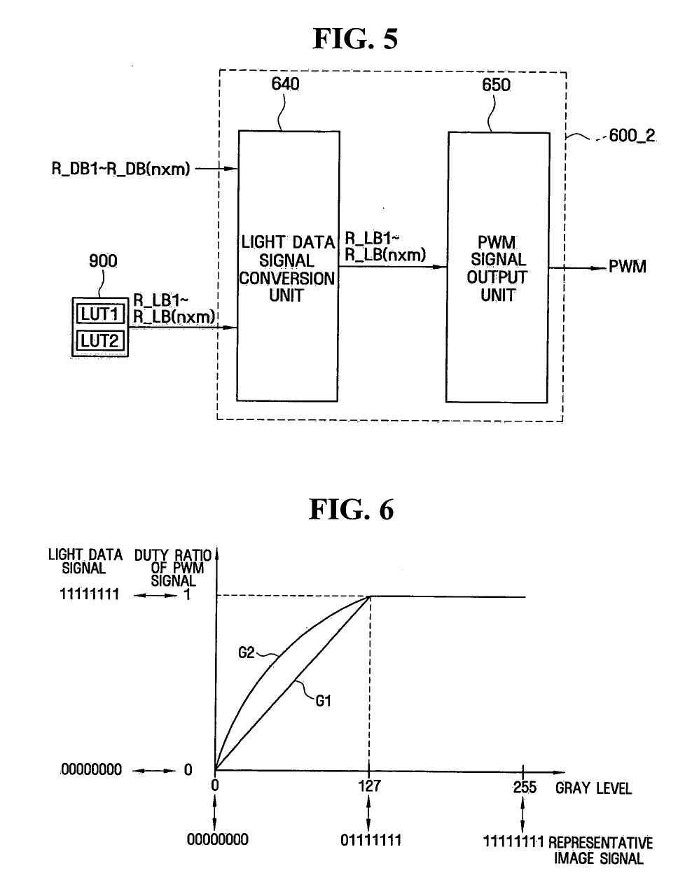

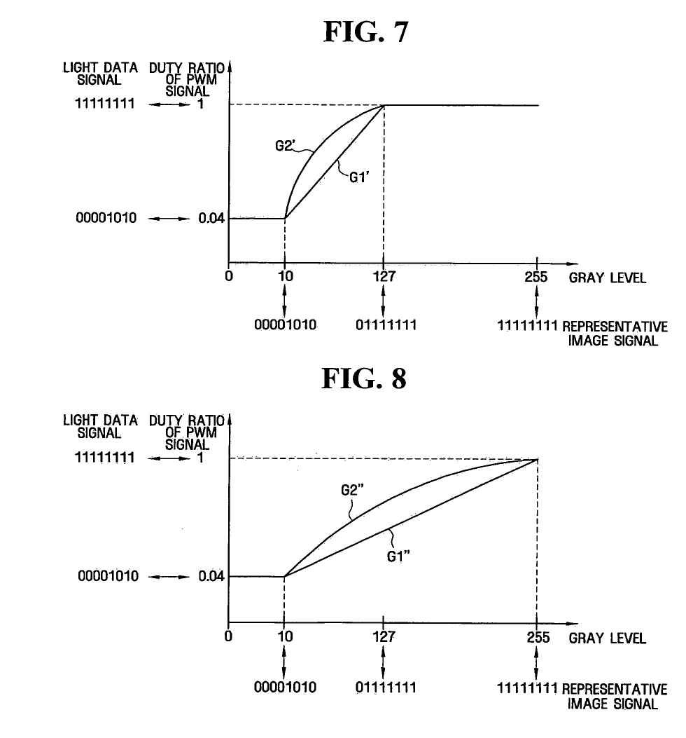

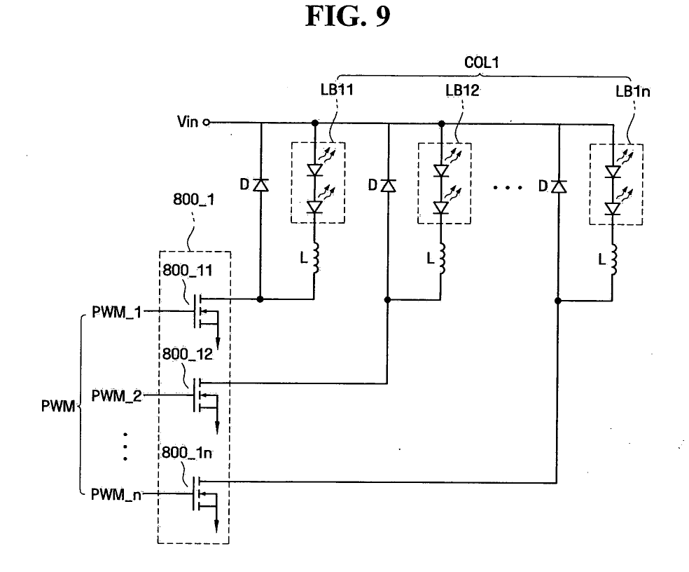

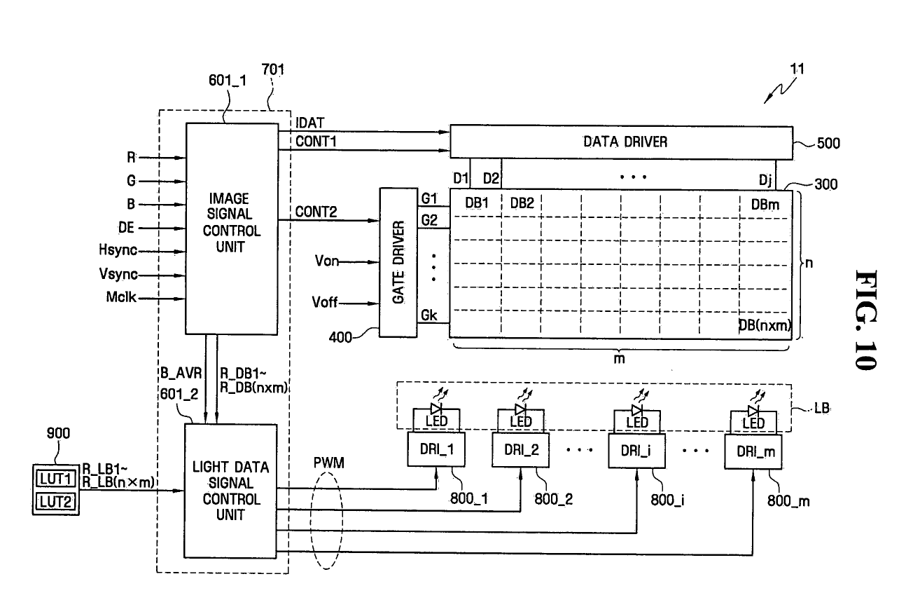

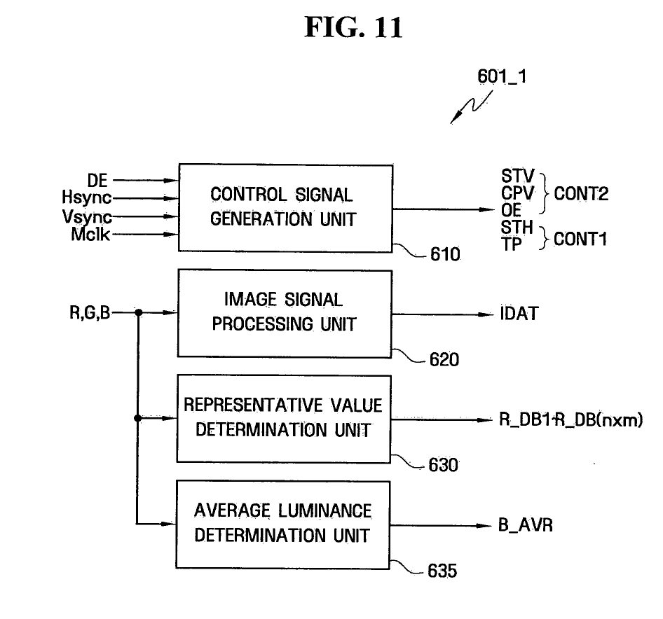

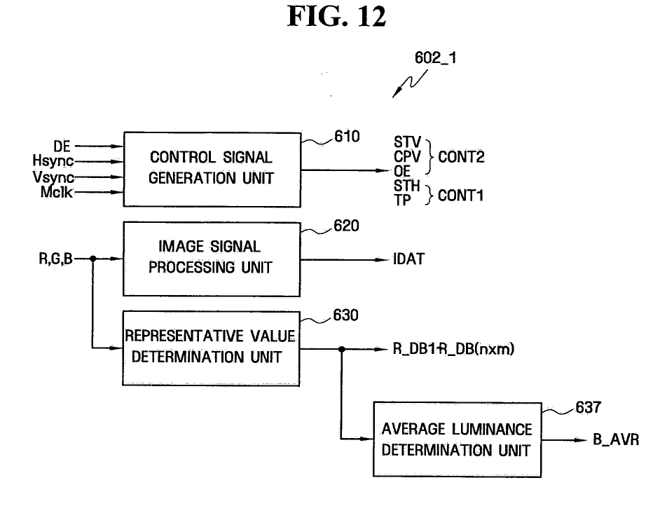

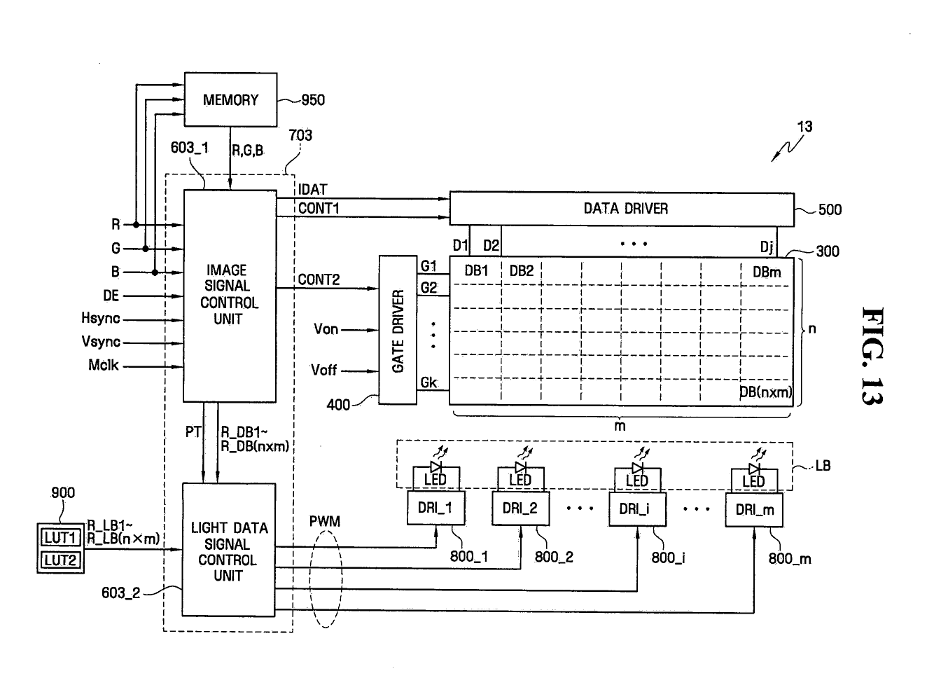

### FIELD OF THE INVENTION

The present invention relates to a Chinese character encoding system and method, and more particularly to a system and method for encoding each Chinese character or word with a 3 bit Unicode Differentiation Index which can be used to identify the pronunciation of the encoded word, map each encoded Chinese word with its corresponding simplified Chinese or traditional Chinese counterpart, and act as a font file differentiator in dual-script-in-one applications.

### BACKGROUND

There are many homographs in Chinese language. Those homographic Chinese words are the same in form but they are pronounced differently and have different meaning. Example: Chinese word [symbol] can be pronounced as [symbol] or [symbol] or [symbol] (Bopomofo script is used here to designate the pronunciation of Chinese). There is no fail safe way to do text-to-speech in Chinese due to this homograph problem. Typically the solution is to train the text-to-speech software to decide which pronunciation is to be used in each context with the help artificial intelligence. Not only would this require very large database to support the decision, it is not fail safe.

That is foreseeable. You see when a Chinese word, such as [symbol] has two pronunciations ( [symbol] or [symbol] ), then word-to-sound relationship is 1-to-2, not 1-to-1. In a 1-to-2 relationship, it is difficult to decide which one of the two options is correct.

The conversion between traditional Chinese words and simplified Chinese words relationship is difficult for exactly the same reason. For example: The simplified Chinese word [symbol] corresponds to three traditional Chinese words, namely [symbol] and [symbol] . So to convert this simplified Chinese [symbol] to traditional Chinese is a very difficult task. It is a 1-to-3 relationship, not 1-to-1.

Microsoft Word can't do it right. For example: This following simplified Chinese sentence [symbol] [symbol] , if transformed to traditional Chinese text by Microsoft Word, will become [symbol] [symbol] and that is a mistake. In this context [symbol] should be transformed to [symbol] not [symbol] . Actually Microsoft Word would fail very often when it encounters the conversion of simplified Chinese words to traditional Chinese words.

In the example just cited, the relationship of simplified Chinese word to traditional Chinese word is 1-to-3. No wonder Microsoft Word will make mistake. It's not fail safe because the failure is built in with such one-to-many relationship.

Thus, there is a need for a reliable method and system for associating each Chinese word with its intended pronunciation as well as provide a utility to transform traditional Chinese sentence to simplified Chinese sentence and vice versa.

Furthermore there is a need of a method and system that allows users to directly generate some special educational scripts that are of dual-script-in-one nature, in which each displayed Chinese word has a phonetic script beside or above or below the ideographic Chinese word, such as the following sample words: [symbol] , [symbol] and [symbol] . We shall refer to those dual-script-in-one scripts as Dualese hereinafter. Such Dualese words have hitherto not been made available to general Chinese input method users because there is no fail safe way to decide the correct phonetic part of the script, for the same reason that text-to-speech cannot be done in a reliable and error free manner.

### SUMMARY OF THE INVENTION

The objective of the present invention is to provide a reliable method and system to resolve the 3 problems mentioned above, namely the text-to-speech problem, the problem of conversion between traditional and simplified Chinese, as well as the Dualese problem.

Another objective of the present invention is to make the functionality & utility of the present invention easily adaptable in the commonly available software applications.

Accordingly, in order to accomplish the above objects, the present invention provides a system and method for encoding a “Unicode Differentiation Index” (hereinafter referred to as “UDI”) value to a plurality of Chinese words allowing this UDI data to identify the intended pronunciation of each encoded word, to associate each encoded traditional Chinese word with a correct simplified Chinese counterpart (and vice versa) and to utilize the encoded UDI data as the font file differentiator in a multi font scheme that will allow users to generate correct Dualese script by using the correct font file for displaying each given Dualese word.

The UDI for each Chinese word along with a specific pronunciation is derived in a 9 step process to be described in details in section DETAILED DESCRIPTION OF THE INVENTION.

The UDI is to be encoded as the 3 least significant bits of one of the three component color of the foreground color of each given Chinese word. Current worldwide text format standard for word processing software is RTF (Rich Text Format). Such RTF text is handled by every word processing software in the world. And RTF formatting allows each word to have an individual font feature, which includes font name, font size, whether bold, whether italics, whether underline and a foreground color. The foreground color has three component colors, namely red, green and blue. Each of the 3 basic colors is assigned a value between 0 and 255. The total number of variations in a foreground color is 16,777,216 (256×256×256). Some of the values of common colors are:
Black color: Red=0 Green=0 Blue=0
White color: Red=255 Green=255 Blue=255
Red color: Red=255 Green=0 Blue=0
Yellow color: Red=255 Green=255 Blue=0
Brown color: Red=103 Green=51 Blue=0
Orange color: Red=255 Green=153 Blue=0

Note for human visual perception, variation of a single component color by a few point is very difficult to detect. So for black color if the component color is changed to ‘Red=6 Green=0 Blue=0’, human eyes would still see the color as black. So is true for every other major color.

Therefore, when foreground color is assigned to a text word, slight variation of one of the component colors shows very little difference in human observation.

This invention manipulates minor color differentiation of the foreground text color to store UDI value into the least significant 3 bits of the 8 bits color code of one of the 3 component colors. Note here the 8 bit color code is how computer store a value between 0 and 255. The least significant 3 bits are thus used by our method to store information that is not related to color.

This scheme (to encode UDI as the 3 least significant bit of a component color of the foreground color) does not really affect the normal functionality of allowing user to specify a color for his/her text. Example, if user wants to assign orange color to a certain text, he/she would choose from a color palette a color with ‘red=255 green=153, blue=0’. But if the Chinese input program that utilizes the method of this invention changes this user selection to ‘red=255, green=153, blue=4’, the user is still going to see an orange color text. It is unlikely that this slight change in one of the 3 component color would create any inconvenience in the functionality of allowing users to choose color for his/her text. Such is an extremely small price to pay to have very important data stored in the foreground color code.

The 3 least significant bits of a component color would allow the storing of a value between 0 and 7. And this capability to store 8 possible code values is enough for the intended functionality of UDI.

The UDI data thus stored in the RTF format of a Chinese text can be utilized to resolve the 3 problems that we described above. Full details of the implementation of UDI in the solutions of the problems is disclosed in section DETAILED DESCRIPTION OF THE INVENTION.

### DETAILED DESCRIPTION OF THE INVENTION

The following description is full and informative description of the best method presently contemplated for carrying out the present invention which is known to the inventors at the time of filing the patent application. Of course, many modifications and adaptations will be apparent to those skilled in the relevant art. While the method described herein are provided with a certain degree of specificity, the present invention may be implemented with either greater or lesser specificity, depending on the needs of the user. The present description should be considered as merely illustrative of the principles of the present invention and not in limitation thereof, since the present invention is defined solely by the claims.

The first step of the method of this invention is the generation of a first list of pronunciation reference number (hereinafter referred to as “PRN”). Chinese has approximately 1350 possible pronunciation. Any sound reference system that gives each possible pronunciation a unique value can be used as the PRN in this usage.

Then a second list of all or a subset of all traditional Chinese Unicode words that the method plans to cover in its system is created. Note a computer implemented method can choose to cover any number of Chinese words for its intended purpose. For beginner level users typically a smaller number of Chinese words will be included. For advanced users typically a larger number of Chinese words will be included. We refer to the field name of this second list hereinafter as TCU.

Each TCU of the second list is then linked with each of the PRN value that is associated with it to form the third list. As mentioned in any above sections, in Chinese language, one Chinese word may be associated with multiple pronunciations because of homographic phenomenon. Consequently, the number of rows for each associated TCU-PRN pair will be larger than the number of TCU in the second list since each TCU with each possible PRN is presented in a separate row in the third list. This third list has two fields, namely TCU and PRN.

The third list is sorted subsequently, with reference to PRN, to a new list. The resulting fourth list is thus sequenced on PRN value; and multiple TCU words of same PRN are grouped together. Due to the homophone phenomenon in Chinese, most sounds have multiple Chinese words associated with them with some sounds have over 40 TCU words associated with them. So there is a need to differentiate the multiple TCU words for each pronunciation.

To differentiate those ‘multiple TCU words’ of the same sound, we need to construct a 2 dimensional matrix (such as a matrix of 7 rows and 9 columns) for each sound to accommodate all the associated TCU words. One TCU Chinese word would take up one cell. The index ROW, COL (being row number, column number) of each TCU word could then serve as a unique identifier of each of the word in this word matrix.

Those 2 index values (ROW and COL) together uniquely identifies a single Unicode Chinese words among all the Unicode Chinese words associated with one unique pronunciation. And these 2 index value plus the PRN value together uniquely identifies a single Unicode word with a defined pronunciation reference PRN.

Such a Unicode word with a defined PRN and 2 word picking index (ROW and COL) is most useful in resolving the 3 problems we outlined in the background section. This composite value PRN+ROW+COL is actually the smallest semantic unit in Chinese language as it identifies a word (TCU) and its pronunciation PRN. So we name this composite index PRN+ROW+COL as SSU (smallest semantic unit in Chinese language).

We then use the data of all the matrixes constructed above to add two more fields (ROW and COL) to the fourth list to generate the fifth list. This fifth list has four fields, namely TCU, PRN, ROW, COL. An alternative way of looking at this fifth list is to consider it to consist of field TCU and composite field SSU, which is the congregate of PRN, ROW and COL.

We further add a new SCU field, which is the simplified Chinese counterpart of the TCU word, to the fifth list to become the sixth list. This sixth list has five fields, namely TCU, SCU, PRN, ROW, COL. An alternative way of looking at this sixth list is to consider it to consist of fields TCU, SCU and a composite field SSU, which is the congregate of PRN, ROW and COL.

Note that both traditional Chinese and simplified Chinese are part of the Unicode system. Majority of the two forms of Chinese are of identical Unicode value. Only some 3000 or so simplified Chinese words are different than the traditional Chinese counterparts.

So the implication of the sixth list is that each unique SSU (PRN+ROW+COL) uniquely define one traditional Chinese word TCU, one simplified Chinese word SCU while the TCU value and SCU value may be identical.

Now we need to create another list to find out the UDI (Unicode Differentiation Index). This is the special encoding value we will encode as 3 least significant bits of one component color of each Unicode Chinese word. This special encoded value will allow us to identify not only unique pronunciation information, but also the traditional-to-simplified relationship of each Unicode Chinese word.

In order to do so, we must realize that the special encoding method described above applied to each text word (which is a Unicode value). The aim of the special encoding of UDI onto each word is to differentiate those ‘identical Unicode words with a differentiating index.

In order to differentiate the members of any group we must first construct the group; then we find a way to differentiate each member of that particular group. We follow that simple logic and designed the following steps to achieve our goal of creating the much needed UDI.

Note now we have generated the sixth list, which composes of TCU, SCU and SSU. And we know both TCU and SCU are of Unicode value. We now create a seventh list that has two fields—UV (Unicode value) and SSU (smallest semantic unit in Chinese). We convert each row of the sixth list into two rows of the seventh list.

The conversion goes like this: for each row of TCU, SCU, SSU we generate two rows. Row 1 is using TCU, SSU of the sixth list as the UV, SSU of the seventh list. Row 2 is using SCU, SSU of the sixth list as the UV, SSU of the seventh list.

This seventh list has twice the number of rows as the sixth list as each row of the sixth lists becomes two rows in the seventh list.

The seventh list then go through the process of sequencing by the UV value, then removing all redundant rows. This process generates the eighth list.

In this eighth list, words of identical Unicode value (UV) are all group together, each with a different SSU (since duplicate rows are removed).

Now we add a new field UDI to this eighth list to become the ninth list. The process of filling up the UDI field for each record is based on the principle that each member of identical UV will be given a number from 0 to 7. With the UDI added into the ninth list, each SSU now corresponds uniquely with a unique UC+UDI value.

This UDI number can then be encoded into the Chinese word in the inputting process. Note when users use pronunciation based input method to do inputting, he/she would first give full indication of the pronunciation (thus PRN is given); then he/she would pick a word from a word list (thus UV is given and the picking process will yield ROW and COL). With all those information (PRN, ROW, COL, UV) available, the software can then proceed to look up ninth list (UV, UDI, SSU) and obtain the UDI value. The software can then proceed to encode the UDI value as the least significant 3 bits of one of the 3 component color (red, green, blue) of the foreground color of the word that user just picked.

Subsequently this UDI value can be used by the same or other software program to resolve the 3 issues that are mentioned in the background section.

To resolve the first problem of text-to-speech, the software program that utilizes the method of this invention can get the UDI of a given Unicode word from its RTF text and the program would be able to retrieve SSU from the ninth list, using UPI and lookup index. The SSU (which is PRN+ROW+COL) thus retrieved can provide the exact pronunciation with its PRN value. The problem of text-to-speech is thus resolved with 100 percent accuracy.

To resolve the second problem of the conversion between traditional Chinese and simplified Chinese, the software program that utilizes the method of this invention will be able to use the SSU and sixth list to find out both the TCU and SCU. So any encoded Chinese word can be easily converted to its traditional Chinese counterpart or its simplified Chinese counterpart. Using this method, following simplified text [symbol] [symbol] can be converted to [symbol] [symbol] correctly. So the second problem of conversion between traditional and simplified is also resolved with 100 percent accuracy.

To resolve the third problem of generating correct Dualese script for each Chinese word, the software program that utilizes the method of this invention will be able to use the UDI as font file differentiator and thus retrieve the font information of the Chinese word from one of 8 possible font files. Example: the word [symbol] is using font name Dualese0 while [symbol] is using font name Dualese1. The suffix 0 or 1 is determined by the UDI. In this case, the UDI acts as font file differentiator. Another example showing multiple fonts used on the same Chinese word in one sentence is [symbol] [symbol] . In this sample Dualese text, the second word [symbol] and the last word [symbol] are the same Chinese word (same Unicode value). But they have different pronunciation. And with our special encoding method, the inputting program can assign each word with an appropriate font file, thus ensuring each word generated to be of the correct phonetic symbols. In this example, the font file used is “Dualese1” for the second Chinese word [symbol] and “Dualese0” for the last Chinese word [symbol] . This application is not possible without the Unicode+UDI data. So now the third problem of allowing users to create correct Dualese scripts is also resolved with 100 percent accuracy.

What is claimed is:

1. A computer implemented method of encoding Unicode Differentiation Index onto a plurality of Chinese words as the least significant 3 bits of one of the three component colors of the foreground color of the encoded RTF Chinese text, wherein the method comprising:
generating one first list of pronunciation reference numbers wherein all the possible pronunciations of the Chinese language is assigned a unique pronunciation reference number, hereinafter referred to as PRN;
generating one second list of all or a subset of all traditional Chinese words that the computer implemented method intends to cover in its application, wherein this data field is referred to hereinafter as TCU;
creating one third list comprising TCU and corresponding PRN, using the data in the second list with the pronunciation data in the first list as reference, wherein each possible pronunciation of each listed traditional Chinese word constitutes one entry in the third list;
sorting the third list according to PRN value to a fourth list;
creating one two dimensional matrix comprising multiple cells for each of the PRN in the fourth list;
wherein each cell of the matrix comprises one traditional Chinese Unicode of that particular PRN;
wherein each cell of the matrix is represented by a row number and a column number, wherein they are referred to as ROW and COL hereinafter;
generating one fifth list by adding ROW and COL data to each row of the fourth list, wherein the composite value of PRN, ROW, COL is referred to hereinafter as SSU;
creating one sixth list by adding the simplified Chinese counterpart, hereinafter referred to as SCU, for each TCU in the fifth list;
creating the seventh list using the sixth list wherein each row of the sixth list generates two rows in the seventh list,
wherein one of the generated row is comprising TCU value and corresponding SSU and the other generated row is comprising SCU value and corresponding SSU value;
wherein the field that holds the generated TCU and SCU value is referred hereinafter as UV;
sorting the seventh list based on UV data and remove all duplicate rows, thus generating the eighth list;
generating the ninth list by adding a Unicode Differentiation Index, referred hereinafter as UDI, field to the eighth list, wherein a UDI value is given to each row with the principle of differentiating identical UV words with a differentiating index so that UV words with different SSU can be differentiated by a value between 0 and 7, which is represented by 3 bits of binary data.

2. The method of claim 1, wherein the encoded Unicode differentiation index is used for supporting a text to speech application.

3. The method of claim 1, wherein the encoded Unicode Differentiation Index is used for supporting transforming the traditional Chinese word to the simplified Chinese counterpart.

4. The method of claim 1, wherein the encoded Unicode Differentiation Index is used for supporting transforming the simplified Chinese word to the traditional Chinese counterpart.

5. The method of claim 1, wherein the encoded Unicode Differentiation Index is used as font file differentiator for displaying a text with the correct Dualese font, wherein Dualese refers to a dual script in one type of script.

6. The method of claim 5, wherein the font file differentiator is a font file suffix or a font file prefix.
